(19) United States
(12) Patent Application Publication
(10) Pub. No.: US 2014/0229417 A1
(43) Pub. Date: Aug. 14, 2014

(54) METHODS FOR AND APPARATUS FOR PROVIDING ADVICE BASED UPON TOTAL PERSONAL VALUES

(71) Applicant: Lela, Inc, New York, NY (US)

(72) Inventors: Dmitry Korobkov, Moscow (RU); Robert Davidson, New York, NY (US)

(73) Assignee: Lela, Inc, New York, NY (US)

(21) Appl. No.: 14/179,138

(22) Filed: Feb. 12, 2014

Related U.S. Application Data
(60) Provisional application No. 61/764,508, filed on Feb. 13, 2013.

(51) Int. Cl. G06N 5/04

(52) U.S. Cl. CPC G06N 5/04
USPC 706/46

(57) ABSTRACT

The present invention provides methods and apparatus for associating Products with Emotional Qualifiers and Decision Makers with Emotional Motivators. The associations may then be used to provide advice on a decision to Decision or other decision.

### CROSS REFERENCE TO RELATED APPLICATIONS

The present application claims priority to provisional patent application Ser. No. 61/764,508, filed Feb. 13, 2013, and entitled, “Methods for and Apparatus for Providing Advice Based upon Total Personal Values”, the contents of which are relied upon and incorporated by reference.

### FIELD OF THE INVENTION

The present invention relates to methods and apparatus for providing advice to a user based upon total personal values of the user. The advice may be provided via a distributed network such as the Internet and Total Person Values may be based upon emotional motivators associated with the user.

### BACKGROUND OF THE INVENTION

It is known for search engines to provide feedback to a user based upon objective feedback factors. Feedback factors may be relevance based and calculated via the use of algorithms that weigh a relevance of content of a URL site and/or trending subjects with a search query. Other factors may include paid advertisements that a search provider receives compensation for presenting and/or ordering with a high priority. Still other feedback factors may include a history of interactions that a user has with a particular URL.

Advertisement may be helpful, but does not fully remedy the problem since advertising is almost as much art as it is science. Advertising agencies attempt to ascertain what will appeal to the masses and then position products in a light which it guesses will sell those products. Demographic data is collected and reviewed to study which products appeal to various demographic groups, and advertisement media may be tailored to reach those demographic groups.

Online sales have allowed advertising to evolve and online sellers may now suggest additional products to a user based upon a purchasing history of the user. The advertising agency and seller may have other data sources to quantify user demand which the advertiser and seller may analyze and study to better position themselves with respect to segments of society that may use the advertiser's goods. However this does not necessarily benefit the user, it benefits the advertiser.

There has not existed a tool that may assist a user in making decisions based upon what is good for the user as opposed to what is good for the advertiser or the search provider.

### SUMMARY OF THE INVENTION

Accordingly, the present invention includes a service that will help a user, such as a Decision Maker make a decision. The decision may be related, for example with a Product or Service to purchase. The present invention thereby makes decision making more delightful and successful by being a virtual advocate for the user, wherein “delightful” is determined by what will make a particular user happy, as compared to another user. The present invention recognizes that what makes a particular user happy differs from user to user and leverages a specific user's Emotional Motivators to provide input as to which choice will ultimately make the user most happy.

The present invention advocates according to emotional intelligence and is capable of advocating for the user on the user's behalf by putting the user at the center of the advice provided, based upon Emotional Motivators associated with the user. This differs from other methods that may advocate for paying advertiser or search engine algorithm result. The present invention is all about the user.

The present may additionally proceed to “know” the user, based upon Emotional Motivators. It advocates and provides suggestions based upon what the user really wants, what the user really likes and ultimately what will make the user happy. In many respects, the present invention provides a deeper understanding of the user's Total Personal Value for available alternatives than perhaps the user is even aware of. The present invention provides knowledge as to the tangible benefits that matter most to the user, and in some embodiments, as a best available price.

In another aspect, in some embodiments, emotional motivators may be continually assessed based upon user actions, or other data received that is relevant to the user. For example, in some embodiments, social media associated with a user may be used to update a user TPV profile.

According to the present invention, a user will input a decision for which an answer must be selected. Answer selections are associated with emotional qualifiers and compared to a TPV profile. In some embodiments, the comparison includes a weighting of answer selections according to the user's TPV Profile. The user is then provided guidance based upon the weighted answer selections. Some implementations may also include providing to the user which emotional qualifiers were included in providing weighted answer selections.

Various embodiments may include input received into a computer server via a distributed network and processed to generate an association of one or more emotional motivators with a user. In some specific embodiments, a user may include a Decision Maker. In addition to answer selections, one or both of Products and Services may also be associated with emotional qualifiers. A software engine included in the server may match the emotional motivators with the emotional qualifiers and provide suggested answer selections based upon the match of the emotional motivators and emotional qualifiers. Emotional qualifiers represent which emotional motivators may be met by a particular answer selection. In some preferred embodiments, emotional qualifiers are associated with “hard” dictionary classifications and “soft” dictionary classifications.

In some preferred embodiments the server provides a user with guidance relating to a question, which may include one or more of: a Decision, a life event, a vacation, a pet selection, a person to date, a university or other institution of education to attend or other decision which may involve Emotional Motivators associated with Emotional Qualifiers. An interactive assessment of the Decision Maker's emotional motivators may be provided online or via a cellular service and thereby become widely available for use by a Decision Maker.

A related aspect of the present invention provides methods and apparatus for generating and presenting an interface which facilitates associating a user's TPV in with answer selections that will make that particular user happier with a chosen answer selection. The interface may be presented over a distributed network, such as the Internet.

In some respects, the present invention may be implemented to determine what matters most to a user and then correlates a decision, such as which answer selection to choose according to what motivates an associated user. In some preferred embodiments, steps directed to determining what matters most to a user are determined via “playful” activities. Other embodiments may include traditional question and answer input. Still other implementations determining what matters most to a user is determined according to a social media profile and social media content associated with a user.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments of the present invention.

FIG. 1 illustrates a block diagram of a prior art method of steps a Decision Maker may take in making a Decision.

FIG. 2 illustrates a block diagram of functional modules that may be used to implement embodiments of the present invention.

FIG. 3 illustrates a block diagram of a Decision process that may be used to implement embodiments of the present invention.

FIG. 4 illustrates a block diagram of decision functions that may be included in some implementations of the present invention directed to a Decision.

FIG. 5 illustrates a block diagram of decision functions that may be included in some implementations of the present invention directed to a non-Decision decision

FIG. 6 illustrates a block diagram of functionalities that may be used to implement some aspects of the present invention directed to associating emotional attributes with Products.

FIG. 7A-7C illustrate block diagrams of exemplary user interfaces including functionalities that may be included in a user interface used to implement some embodiments of the present invention.

FIG. 8 illustrates apparatus that may be used to implement some embodiments of the present invention.

FIGS. 9A-9B include flow diagrams of method steps that may be included in some implementations of the present invention.

FIG. 10 illustrates a block diagram of a Total Personal Value system utilized in generating a TPV Profile for a user.

FIG. 11 illustrates how the present invention may assist a user in making a delightful decision.

### DETAILED DESCRIPTION OF PREFERRED EMBODIMENTS

The present invention provides automated apparatus with one or more processors and executable software, wherein the software is executable upon demand to assess emotional motivators related to making a decision and generate a Total Personal Values Profile. For the purposes of this discussion, a “User” or multiple “Users” include one or more uniquely identified individuals, or a succinctly defined organization. The present invention collects or otherwise receives subjective and objective data and associates the subjective and objective data with emotional motivators. The collected data is digitally stored as a TPV Profile which may be applied and built upon in order to assist with life decisions.

Executable software is operative in conjunction with a processor to execute methodologies that match emotional motivators to purchasing decisions. Emotional motivators may be associated with one or more of: an individual actually making a decision; a person who will be directly affected by a decision and an organization that will be directed affected by a decision.

Glossary:

As used herein the following terms will have the following associated meaning:

“Decision Context” includes circumstantial data related to a Decision.

“Cross Channel” using data related to a first Decision in a first subject area with a second Decision or other decision in a second subject area.

“Decision Maker” as used herein shall mean a person that makes or contemplates making a Decision.

“Emotional Reasons” as used herein Emotional Reasons means subjective emotional motivators that form a basis for satisfaction following completion of a decision, such as, for example, a decision related to one or more of: a purchase, a life event, a vacation, a pet selection, a person to date, a university or other institution of education to attend.

“Emotional Motivator” as used herein shall mean, a psychological factor associated with a user, such as a Decision Maker, wherein the factor influences satisfaction with a decision.

“Emotional Qualifier” a qualification associated with an inanimate Product or a Service, wherein the qualification may influence emotions associated with the Product or Service.

“Engine” as used herein refers to an apparatus including a processor that executes a software process to receive one or more inputs, process the inputs, and generate an output based upon the inputs.

“Local” in geographic proximity reasonable to travel to make a Decision based objective and subjective aspects of a Decision, which may include, for example a size of a Decision, the availability of a Product to be Decision and timing of when a Product is needed.

“Motivator” as used herein shall mean a factor which influences a sense of success in making a decision.

“Personal Benefit” as used herein shall mean receipt of Emotional Motivators by a user. Receipt of the Emotional Motivators may be accomplished, for example, via a user acquiring a Product or Service or attending a social event.

“Product” for the sake of simplicity in this discussion, as used herein a Product shall mean one or more of: a tangible item, machine or device; an intangible conveyance such as knowledge, know how or data stream; and a Service performed (as defined below).

“Service” as used herein shall mean an action performed at the request of a Decision Maker.

“Total Personal Value” sometimes referred to as “TPV” as used herein shall mean an aggregate of Personal Benefit received by a user divided by an amount given or “paid” for the receipt of the Personal Benefit. An amount may include a pecuniary amount or some other exchange of a thing or service or emotion.

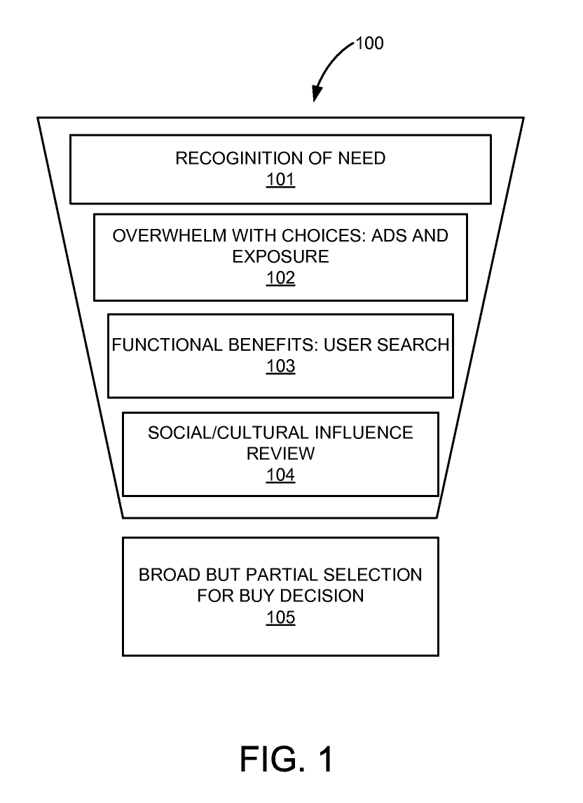

Referring now to FIG. 1, a block diagram 100 illustrates a prior art method for a Decision Maker to make a decision to Decision a product or service. At 101, the Decision Maker recognizes a need for one or both of a Good and Service.

A need may be essentially objective and functional in nature, such as a portion of a defined process, for example a replacement part of a machine, such as an automobile.

A need may also be subjective or psychological, such as a need to decide upon a practice or a gift to celebrate an event.

At 102, a Decision Maker looking for input may be overwhelmed with choices, advertisements and exposure to media promoting select Decision choices. The view of Product and Service choices is also limited to those choices that are actively advertised and promoted. At 103, a Decision Maker may search functional benefits. The search may reveal information about a product or service, a price and a comparison to other available products. At 104, social and cultural influence may also affect a purchasing decision. The social and cultural influence may include one or more of reviews, ratings and comments descriptive of products.

At 105, the prior art method at best provides a broad amount of information but only partial in regard to a specific Decision event.

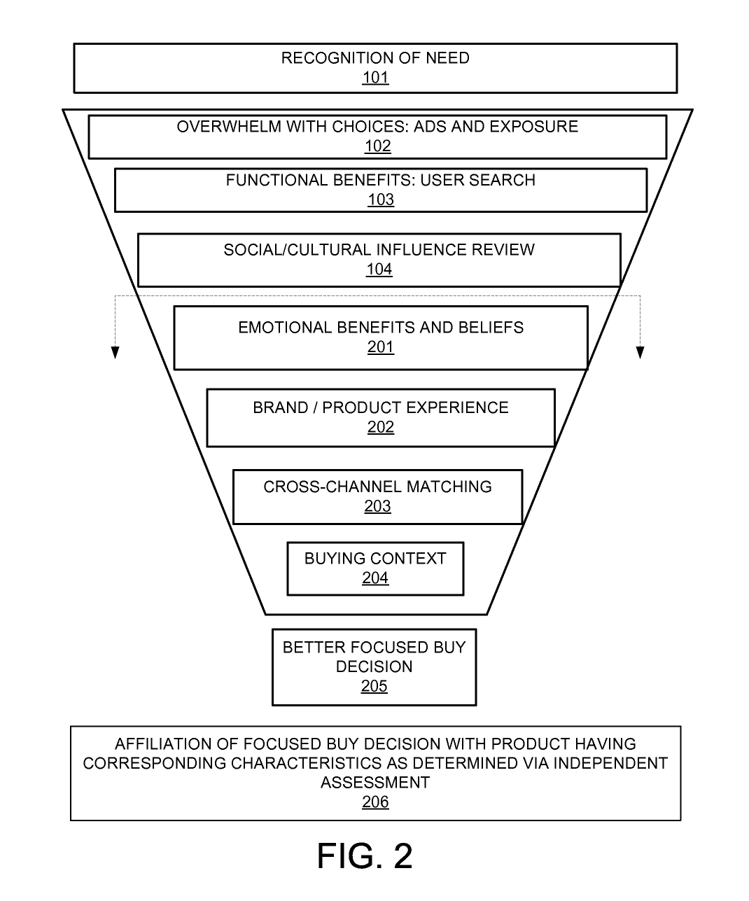

Referring now to FIG. 2, functional steps that may be executed according to the present invention are illustrated. At 201, one or both of emotional benefits and beliefs are assessed.

Emotional benefits and beliefs may be on a conscious or unconscious level and access values inherent in a Decision Maker. In some preferred embodiments, discussed more fully below, a Decision Maker will provide value related data as input into a computerized apparatus, wherein the data may be processed by a programmable algorithm to correlate the input data with one or more core values useful to make a purchasing decision. Emotional benefits may include, for example, whether a Decision Maker believes that it is good to own or to buy Products that make the Decision Maker stand out, or that it is good to own or to buy Products that are ecologically friendly and which make the Decision Maker feel responsible.

Another example of an objective need may include a need for a carriage to carry a baby during a jogging activity. A need that is essentially subjective includes a need for a stylish baby carriage that will make the Decision Maker appear chic.

At 202, in addition to value based data, the computerized apparatus may include one or both of brand and product experience. A Decision history may also be used, in addition to brand loyalty, or in place of brand loyalty.

At 203, in some embodiments, cross channel matching may be implemented. Cross-Channel matching includes determining an emotional reason for affinity to a first one or more of: a brand, a Product; and a service. With Cross-Channel matching, one or more Emotional Reasons is stored and made available to be applied to at least a second one or more of: a brand, a Product; and a service. The application of the Emotional Reason to the selection of a second brand, Product and/or Service, facilitates a recommended choice of Decision of the second brand, Product and/or Service.

At 204, a Decision Context may also be considered in making a recommendation of a Decision. A Decision Context may include, for example, whether the Decision will be: made during travel; from a local vendor (or at least a vendor with a local presence); for a gift for another person; is associated with a holiday; or has specific timing constraints. By way of non-limiting illustration, a buying decision may be for a gift that will be picked up during travel to a particular destination and during particular calendar days. In another illustrative example, a Decision may be for a person supplying emotional motivators and be for a Decision that will be made local on a same day as purchasing research is conducted.

At 205 a Decision Maker is presented with a better focused buying decision. The focus may include a clear representation of who, what, where and when a Decision will be made.

At 206, the present invention correlates a Decision Maker's Emotional Motivators with a Product having corresponding Motivator characteristics as determined via an independent assessment of the Product (discussed further below).

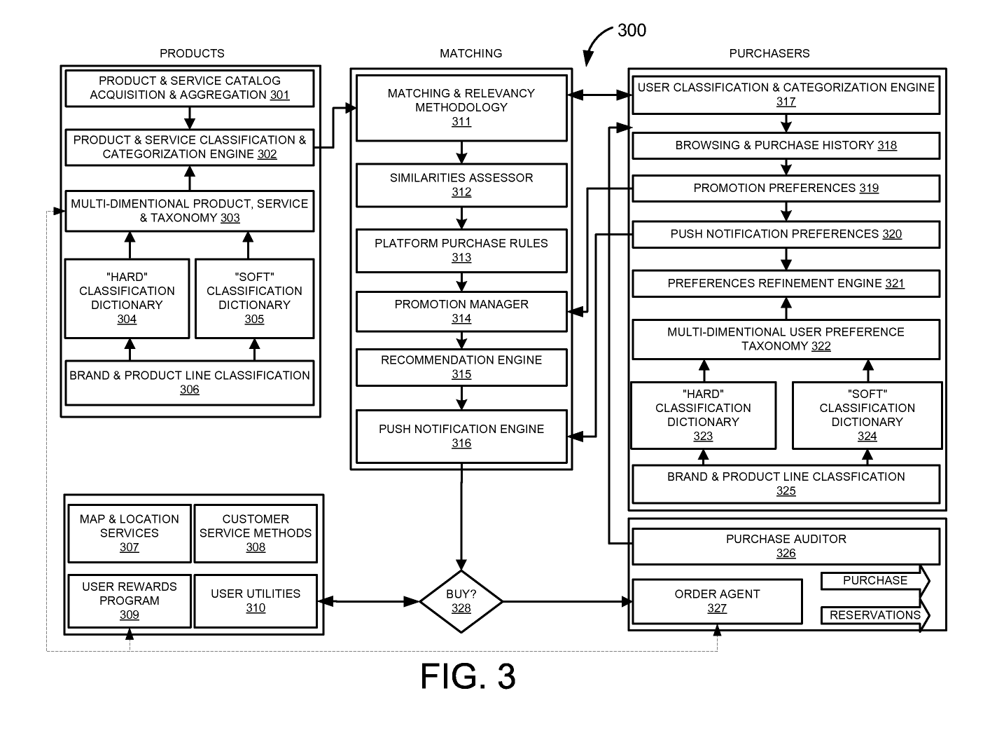

Referring now to FIG. 3, a process 300 is presented according to some embodiments of the present invention. On a high level, the process includes method steps that may be implemented to practice novel aspects of the invention, including, for example, associating Emotional Motivators to Products and Services; associating Emotional Motivators with a Decision Maker, and matching one or more Products and Services with a Decision Maker. At 301, data is aggregated which is descriptive of one or more Products. The data may include, for example, catalogs, whether physical or virtual with information quantifying aspects of a Product.

At 302, the aggregated data is input into a Product and Service Classification and Categorization Engine. In essence, the engine is a computerized apparatus with programmable code. The programmable code is executable upon demand to parse, sort and link various aspects of the aggregated data according to one or both of predefined taxonomies and relationships and taxonomies and relationships “grown” as a result of data analysis. For example, it is within the scope of the present invention to associate product data with taxonomies and relationships previously encountered by a Product and Service Classification and Categorization Engine or have the engine create new taxonomies and relationships, based upon aggregated Product data received.

At 303, multi-dimensional data may therefore be generated which includes taxonomy tables relevant to a Product and which excludes taxonomy tables not relevant to a Product.

At 304, in some preferred embodiments, a Categorization and Classification Engine will allocate at least some of the aggregated data into a relatively objective “Hard” Classification Dictionary. A Hard classification may include, for example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

At 305, additionally, some preferred embodiments may include a Categorization and Classification Engine which allocates at least some of the aggregated data into a relatively subjective “Soft” Classification Dictionary. A Soft classification may include, for example, one or more of: luxury, cheap, designer, stylish, urban, suburban, rural, local, regional, global, religious, cultural or other taxonomy or classification which is essentially relative to other taxonomies.

At 306, some exemplary embodiments may also include a recognition of a brand associated with a Product. The brand may include a trademark or other designation that associates a Product with a manufacturer or service provider. It is preferable that the brands also be associated with the taxonomies and classifications included in the hard Classification Dictionary and the Soft Classification Dictionary.

At 307-310, additional considerations are illustrated that may be included in a presentation to a Decision Maker of a Product suitable to the Decision Maker. Additional considerations may include, for example, at 307, a map with an indication of where a Product or Service is available. In some embodiments, a location of a Product or Service may be shown relative to a location of an interested Decision Maker. At 308, customer service methods, conditions, and terms may also be a considered taxonomy. At 309, a rewards program along with the conditions and terms of the program may be in included taxonomy. At 310 user utilities that may also be an included Taxonomy.

A matching engine may include automated apparatus including a processor, a digital storage device and executable software stored on the digital storage and executable upon command to match Products 311 which may include goods and services with Purchasers. At 312, a Similarities Assessor may include executable code for associating Emotional Qualifiers with products and Emotional Motivators with users and base similarities of one or both based upon the associations. A Platform Purchase rules module 313 may be used to quantify the logistics of making a purchase for a particular platform on which the resent invention is implemented. For example, an online website may of a first set of Platform Purchase rules 313 and an in store kiosk may include a second set of Platform Purchase rules 313.

In some embodiments, a Promotion Manager 314 may be included for promoting one or more of: a brand, a vendor, a product and a service. Promotion may include interactions with a user via a graphical user interface. A Recommendation Engine 315 is functional to make a Purchase recommendation to a Purchaser based upon the method steps of the present invention. A Push notification engine 316 may be utilized in some embodiments to provide push services to a user, such as a Purchaser of Product related information, such as, for example , availability of a Product, a price of a Product, a promotion of a Product, or other information.

Considering now a Decision Maker and taxonomies and data that may be input indicative of the Decision Maker's Emotional Motivators, items 318-327 include various aspects of data that may be included by a user categorization and classification engine (sometimes referred to herein as “CC Engine”) 317 practicing the method steps of the present invention. At 318, the CC engine 318 may receive and process data indicative of one or both of a browsing history and a purchasing history of a Decision Maker. A CC Engines may receive and process data indicative of one or both of: promotion preferences of a Decision Maker 319; and push notification preferences of a Decision Maker 320. At 321, a Preferences refinement engine may correlate various Decision Maker preferences and generate preference trends for a Decision Maker. The Decision Maker trends may be included in a multi-dimensional Decision Maker preference taxonomy or other user preference taxonomy, generated by a computerized device implementing the present invention.

At 322, a multi-dimensional user preference taxonomy may be employed which includes input from a Product hard classifications dictionary 323 and a Product soft classifications dictionary 324. The Product hard classifications dictionary 323 may include, by way of non-limiting example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

The Product “Soft” Classification Dictionary 324 may generally include by way of non-limiting example, one or more of: luxury, cheap, designer, stylish, urban, suburban, rural, local, regional, global, religious, cultural or other taxonomy or classification which is essentially relative to other taxonomies.

Product and brand classification may also include recognition of a brand associated with a Product. The brand may include, for example, a trademark, service mark, or other designation that associates a Product with a manufacturer or service provider. It is preferable that brands also be associated with taxonomies and classifications included in the hard Classification Dictionary and the Soft Classification Dictionary.

A Decision Maker may make a decision to execute a “Buy” action 328 and make a Decision. An order agent 327 may be used to implement a Decision instruction associated with a Buy 328 action. As discussed further below, a Buy action 328 may be communicated to a computerized system via a user interactive device. The user interactive device may be any apparatus that is functional to interface between a human and a computerized system. The user interactive device may therefore include, for example, one or more of: a keyboard, mouse other pointing device, touchscreen, auditory voice command, neural interactive device or other apparatus.

The Order Agent 327 may essentially function as an interface between a user instruction and a Decision or reservation system or module. The Order Agent 327 will provide data to a Decision or reservation system or module sufficient for the Decision or reservation module to execute the Decision instruction.

In another aspect of the present invention, a Decision Auditor module 326 may track or audit Decisions made by a Decision Maker, or group of Decision Makers (trending). The Decision Auditor function may provide analysis of purchasing activity and plot any trends that may be present within data of a Decision Maker or group of Decision Maker's history. Accordingly, at a first given time period, a Decision Maker may be primarily motivated by a first set of Motivators which are based upon a first set of Emotional Reasons. During a second time period, a prevalence of a second set of Emotional Reasons may emerge.

For example, during a first time period, a Decision Maker may be primarily motivated by an Emotional Reason of wanting to be stylish or chic. This may correlate, with a period of financial success and significant social interaction. During a second time period, a Decision Maker may be primarily motivated by an Emotional Reason of seeking high quality and durability. This period may correlate with a period of financial challenge and focus on raising a family, or other care giving.

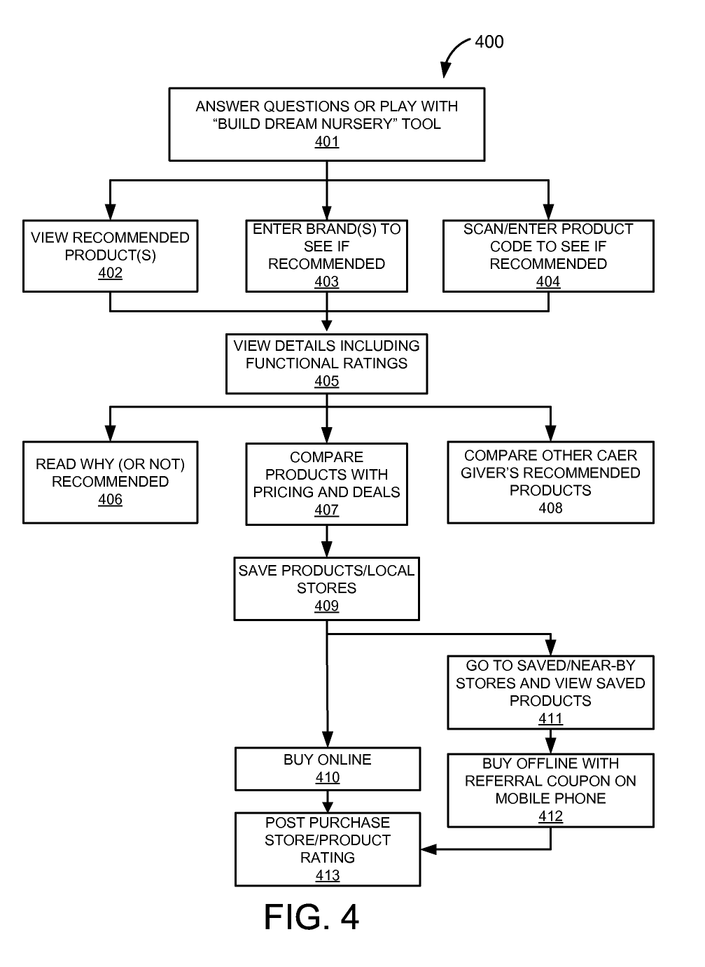

Referring now to FIG. 4, a block diagram 400 illustrates a flow of key user functions across computerized apparatus platforms that may be implemented to facilitate a Decision Maker's decision to make a Product Decision. As with other functional modules described herein, the key user functions may be implemented on a computerized device via executable software, executed upon demand. At 401, a Decision Maker or other user, may provide input which may be used as input into a Motivator engine to determine primary Emotional Reasons the Decision Maker will use to make a Decision. The input may include, for example, answering questions presented to them about seemingly unrelated choices, or “playing” with an interactive virtual reality scene, such as a “Build a Dream Nursery” tool.

At 402, a computerized system implementing the present invention may allow the Decision Maker to view Products which are recommended, based upon input received from the Decision Maker. At 403, a Decision Maker may also designate a Decision Maker preferred brand and the system may indicate if the Decision Maker preferred Brand is included in a list of recommended Products.

At 404, a Decision Maker may also scan a UPC code or another product identifying code and input the code into the system. The code may be accessed, for example while the Decision Maker is shopping in a brick and mortar type store, or at some other time when the Decision Maker is observing a Product, such as, for example, when examining a product decision by a friend. The system may also provide a response indicating whether the scanned item is a recommended item.

At 405, a Decision Maker may view details including functional ratings of Products being considered by the Decision Maker. The details and ratings may be compiled from multiple sources, including, for example, manufacturer specifications, independent reviews, online blogs, government agencies, ratings entities, or other source.

At 406-408, a Decision Maker may receive feedback related to Products of interest to the Decision Maker. At 406, feedback may include, for example, why a Product is recommended, or not recommended. At 407 relative prices and purchasing deals for recommended Products may be compared. At 408, Products recommended by other Product users, such as one or more other care givers may also be provided to the Decision Maker.

At 409, in some embodiments, a Decision Maker may communicate with a store, such as a brick and mortar establishment via a communications network, such as the Internet. Communication with a local store may allow the Decision Maker to check inventory of the store for a preferred Product. In addition, in some embodiments, a Decision Maker may reserve or save a desired Product at the local store so that the Decision Maker may go to the store and review the Product.

At 410, a Decision Maker may complete a Decision of a Product online via a virtual storefront, or a virtual exchange. At 411, a Decision Maker may physically visit a store and view Products the Decision Maker may potentially Decision. At 412 Decision Maker may also make a Decision in the local store. At 413, a Decision Maker may provide to a Purchasing system feedback, such as a rating or other indication of the Decision Maker's satisfaction with a decision product or the suitability of a particular product for a purpose.

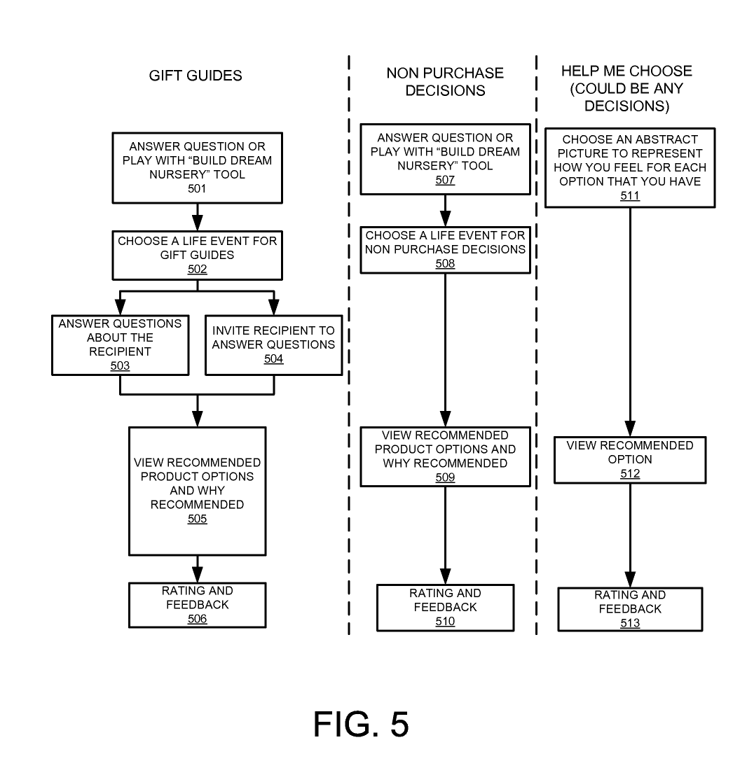

Referring now to FIG. 5, a block diagram illustrates a flow of key user functions across computerized apparatus platforms that may be implemented to facilitate purposes other than a Decision Maker's decision to make a Product Decision. At 501-506 steps are illustrated which allow the present invention to be implemented in situations where a Decision Maker is making a Decision for a gift. At 501, a Decision Maker may answer interview questions. In some embodiments, answers to questions are gleaned from in interactive activity. The interactive may be presented as a virtual game or a virtual tool. For example, one interactive activity may include a virtual “Build a Dream Nursery” activity. A Decision Maker, or in some embodiments, a gift recipient or other relevant person, is encouraged to virtually create a nursery. The present invention, allows a computerized apparatus to track selections made in attributes of the nursery. The attributes chosen may be utilized in lieu of, or in addition to, answers to questions from the Decision Maker or other user.

As part of input to an eventual Product recommendation for a given circumstance, at 502, a life event may be chosen for a gift guide. At 503, a Decision Maker, or other user may provide answers about a gift recipient. The answers may be submitted to a computerized device via any known user interactive tool. In addition, in some embodiments, a gift recipient may be invited 504 to provide answers to questions. For example, a gift recipient may be sent an electronic communication, such as one or more of: an email, a text, and a social media posting. The gift recipient may follow instruction included in the electronic invitation to a website which allows the gift recipient to identify themselves and answer the questions.

At 505, the present invention allows for one or both of the Decision Maker (gift giver) and the gift recipient to view information in a human readable form that is descriptive of recommended Products. In some embodiments, the Decision Maker and gift recipient are also provided with information descriptive of why one or more particular Products are recommended. At 506 one or both of the Decision Maker and the gift recipient are provided with a user interactive interface for providing a rating on a Product and other feedback on one or more of: a Product; the recommendation; and the emotional motivator process for making recommendations.

In another aspect of the present invention, it is noted that an automated system which uses Emotional Reasons and Motivators to assist in decision making is not limited to decisions relating to potential Decisions. Almost any decision may be assisted with an understanding and application of knowledge relating to underlying emotions and motivators.

At 507, a user may undertake one or more activities, such as answering questions or participating in a virtual activity. The virtual activity may include, for example, a game or a tool which provides queries to a user for instructions on how to create something online. At 508, in some embodiments, a life event may be associated with a non-Decision decision which will be made by a user. At 509, the user may view recommendations based upon the input received by, or about, the user. The recommendations may include, for example, one or more of: a recommended action step, or course of action; a Product selection; and a collaboration with a particular person or group of people. At 510, a user interactive interface may provide for a rating or feedback.

At 511, in a still broader, or higher level, implementation, a user may be asked to choose abstract picture or image which represents how a user “feels” or emotionally responds to one or more options presented to the user. At 512, the user or other party (such as a care taker, friend or employer) may view a recommended option. At 513, one or more of the user and another interested party (such as a care taker, friend or employer) may provide rating and feedback information.

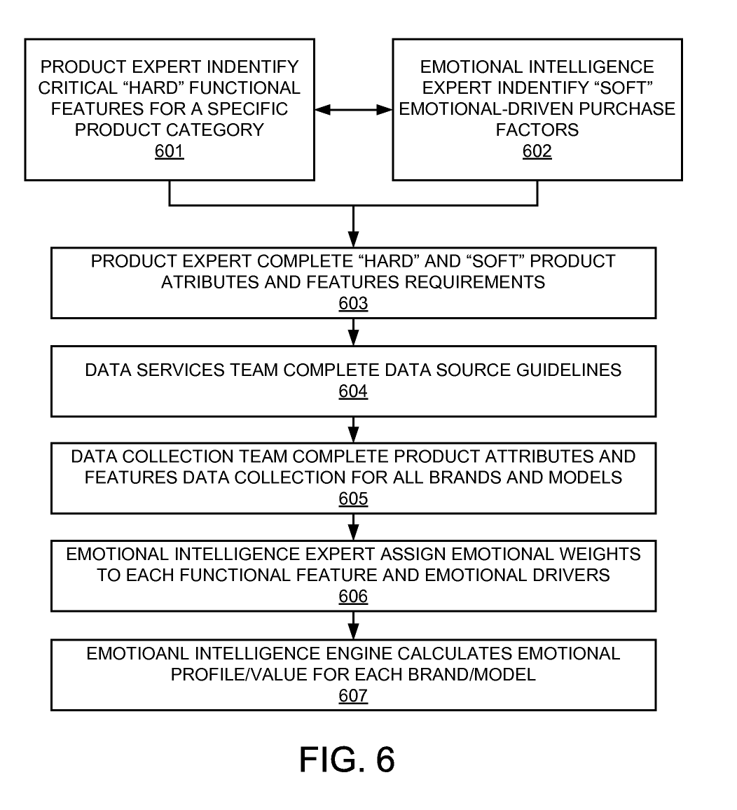

Referring now to FIG. 6, a block diagram illustrates how the present invention utilizes assessments of Products, and associates Products, with both “hard” functional attributes and “soft” emotional attributes.

At 601, the present invention receives input from one or more Product Experts which identify critical “hard” functional features for specific products category, such as, for example a baby stroller, an electronic device, a backpack, or almost any other Product. A hard functional feature may include for example, almost any empirical data, and may therefore include, for example, specifications, power ratings, physical dimensions, or other verifiable fact.

At 602, the present Emotional Intelligence Expert identifies one or more “soft” emotional-driven Decision factors. For example, a Product with a bright color may be associated with an emotional need for attention, a Product with rugged features and durability may be associated with a need to appear masculine. The soft features may be obtained from a database of available features and how those features may translate into, and evoke human emotions.

At 603, a Product Expert may complete a combination of hard and soft product attributes and feature requirements for a Product desired by a Decision Maker or other user. At 604, a data services team may provide data source guidelines for a Product. The data source guidelines may include the data fields and definitions for datum that will be compiled for particular product groups. The data source guidelines will serve as an indication of which data fields should be collected for a particular Product, or Product group.

At 605, a data collection team may be tasked with providing the data fields specified by the Product Experts. The data collection may aggregate an input data values into a database which is made available to various engines to facilitate Product selection based upon Motivators and Emotional reasoning.

At 606, in some preferred embodiments, emotional weights are assigned to at least some, if not all of the functional features and emotional drivers. One natural choice is to have one or more emotional intelligence experts assign weights to functional features, and weights to emotional drivers. A weight may include, for example, an alpha numerical value that is associated with a relative scaled value. Other ratings or weights are also within the scope of the present invention, such as, for example, a color coded value.

At 607, in some preferred embodiments, an Emotional Intelligence Engine calculates a value which is associated with an emotional profile for a Product. The value associated with an emotional profile is preferably stored in a data structure which allows the value to be retrieved upon demand. The value may include multiple dimensions. For example, the value may include a scaled indication of an appearance of fiscal status, such as, for example, the brand name Louis Vuitton™ may represent wealth, another emotional value may provide an indication of durability, another emotional value may provide an indication of subtleness or loudness. Other emotional values may be included within the scope of the invention, wherein any emotional value that may be influential in a Decision or other decision at hand may be included.

### Apparatus

The teachings of the present invention may be implemented with any apparatus capable of embodying the innovative concepts described herein. Image presentation can be accomplished via any multimedia type interface. Embodiments can therefore include a PC, handheld, game controller; PDA, cellular device, HDTV or other multimedia device with user interactive controls, including, in some embodiments, voice activated interactive controls.

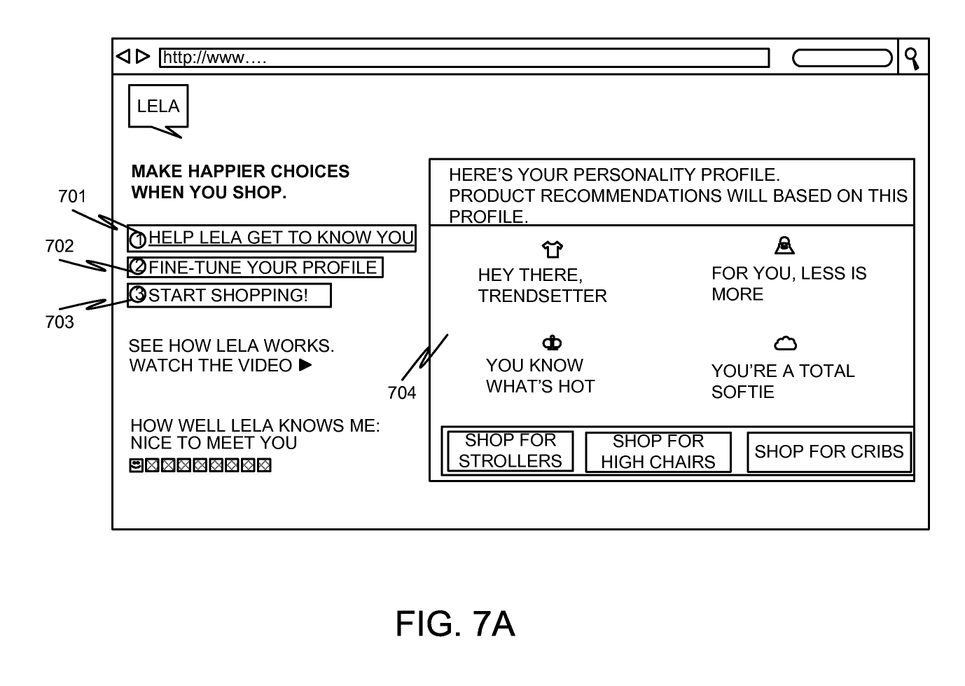

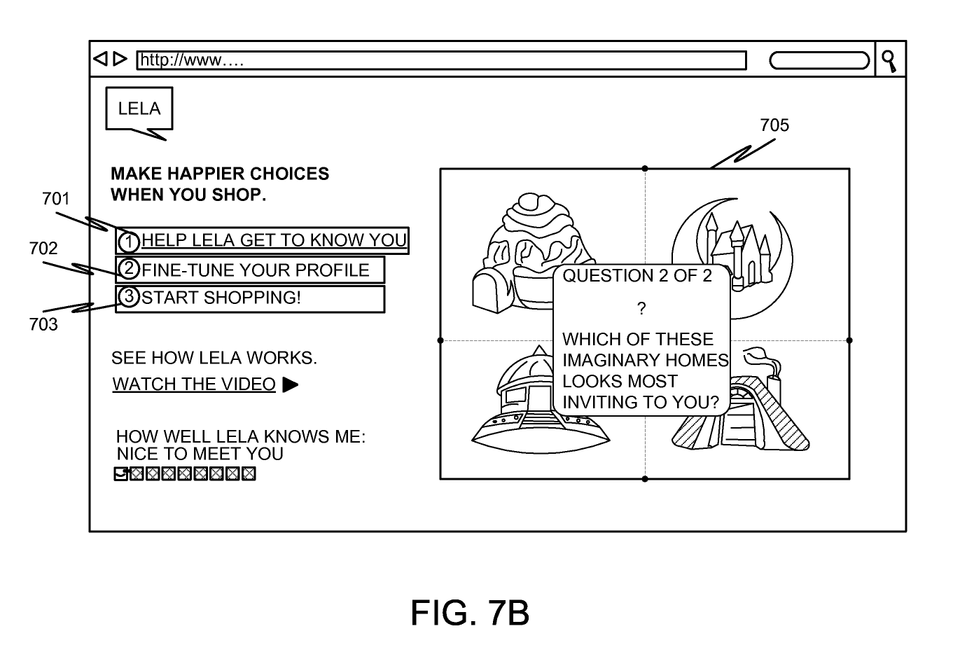

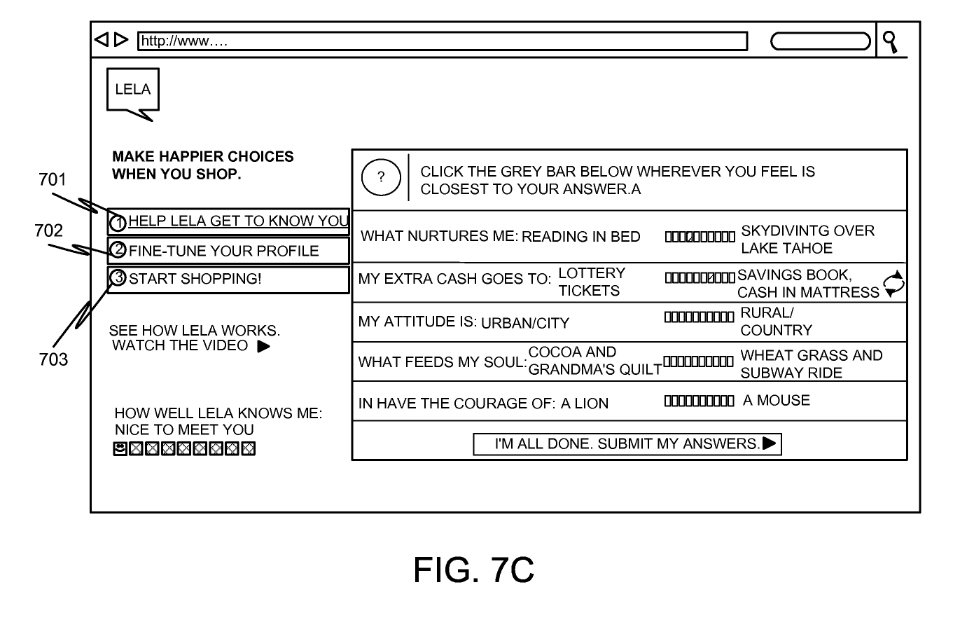

Referring now to FIG. 7A, an exemplary user interactive interface is illustrated. The interface includes multiple user interactive areas which may receive input from a user and provide one or both of human readable content or human recognizable images. Interactive areas may include, by way of non-limiting example, one or more of: a) a user interactive area on a screen that prompts a user of “Help LELA get to know you” 701; b) Fine tune your Profile 702; c) Start Shopping 703.

The Help LELA get to know you interactive area 701 is illustrative of a service such as the LELA™ service. This area 701 may be selected by a user to lead the user through a series of interactive queries designed to educate a LELA software engine about a user. For example, in some preferred embodiments, images may be presented to a user wherein the user is prompted to select one of multiple images in response to one or more questions. In addition, questions may be presented in sentence format and also be used to help LELA “know” the user. In some embodiments, the LELA questions are designed to have the user provide answers that are indicative of one or more emotional motivators that influence the user.

At 702 the user may also be provided with an area that allows the user to “fine tune” or otherwise modify the user profile, including emotional motivators. In some embodiments, a user may use interactive user devices such as icons and prompts to request a new set of images related to a question or to request one or more new questions.

At 703, a user may also choose to begin shopping with assistance of a LELA™ program that relates one or more Products with emotional motivators associated with the user.

At 704, another user interactive area may include an area that provides feedback indicating what Emotional Motivators are associated with the user.

Referring now to FIG. 7B, additional user interactive areas may also include an area that provides an indicator of how well LELA™ “knows” the user. Essentially, how well LELA™ knows a user may be based upon, for example, one or more of: a number of questions answered by the user a number of images chosen by the user; a number of transactions executed by the user, a browsing history, or other forms of input.

At 705, a group of exemplary images is presented, wherein each image is indicative of one or more emotional motivators. Selection of an image by a user may provide input to LELA™ Emotional Motivators that may influence a user.

Referring now to FIG. 7C, in some preferred embodiments, a user interface that receives input indicating emotional motivators of a Decision Maker or other user may include questions that have two questions on a scale, wherein the Decision Maker provides a scaled answer along a continuum formed between the two answers. For example, a Decision may be queried as to what nurtures the Decision Maker. Two answers, such as 1) “reading in bed” and 2) “skydiving over Lake Tahoe”. A scale between the two phrases may have a number of positions with some positions closer to the first answer and some positions closer to the second answer and a position equally distant from the first answer and the second answer. The position chosen provides a weighted indication of an answer closes to how a Decision Maker feels. As illustrated, multiple questions and weighted answers along respective scales may be provided.

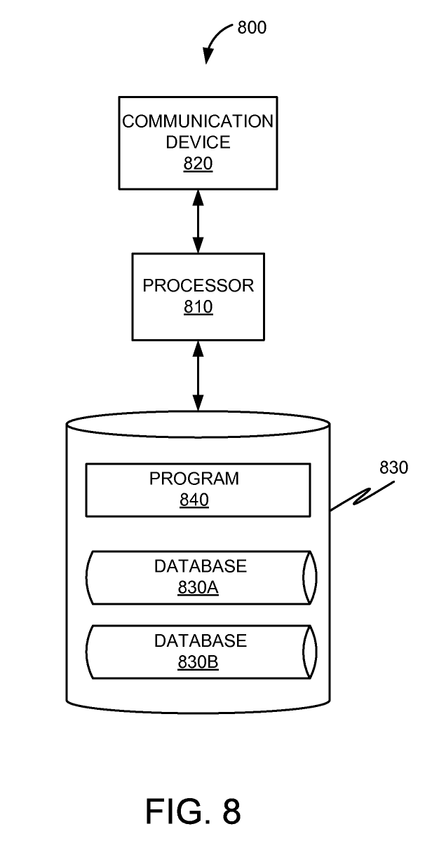

Referring now to FIG. 8, an illustration is provided with a controller 800 that may be embodied in one or more computer servers or communication network access devices and utilized to implement some embodiments of the present invention. A server may include, by way of example, a rack mounted server, stand alone server, a server farm or other embodiment of an automated apparatus for serving content on a communications network, such as the internet. Communications accessible devices may include, by way of example, a hand held device such as a cellular phone, a pad device, a personal computer, a server, a personal digital assistant, an electronic reader device or other programmable device.

The controller 800 comprises a processor unit 810, which may include one or more processors, coupled to a communication device 820 configured to communicate via a communication network, such as the Internet, or other cellular based network such as a 3G or 4G network (not shown in FIG. 8). The communication device 820 may be used to communicate with a digital communications network, such as, for example, the Internet available via the Internet Protocol, or a cellular network such as 3G or 4G.

The processor 810 is also in communication with a storage device 830. The storage device 830 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 830 can store a program 840 for controlling the processor 810.

The processor 810 performs instructions of the program 840, and thereby operates in accordance with the present invention. The processor 810 may also cause the communication device 820 to transmit information, including, in some instances, control commands to operate apparatus to implement the processes described above. The storage device 830 can additionally store related data in a database 830A and database 830B, as needed.

### Methods

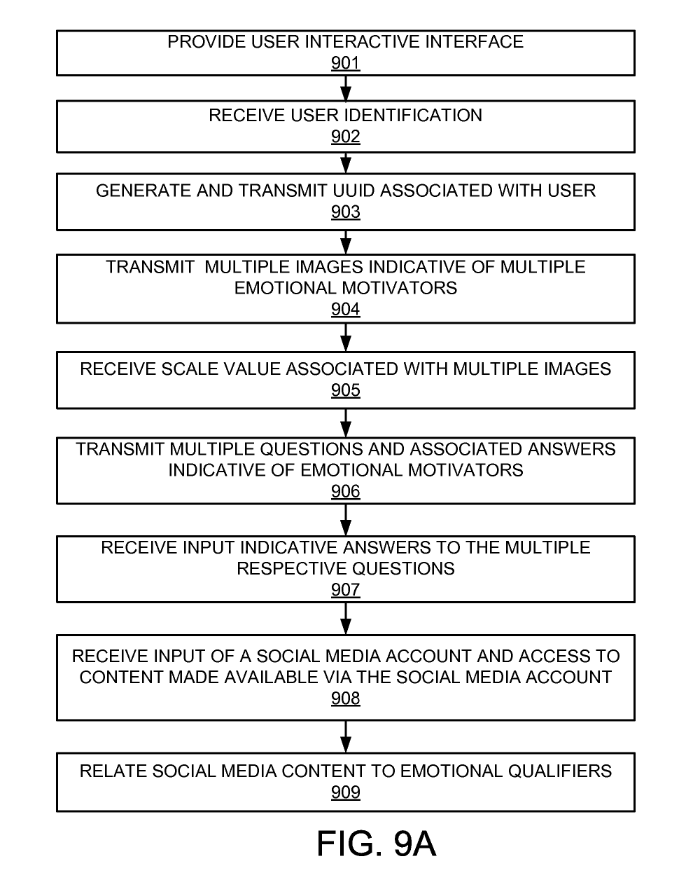

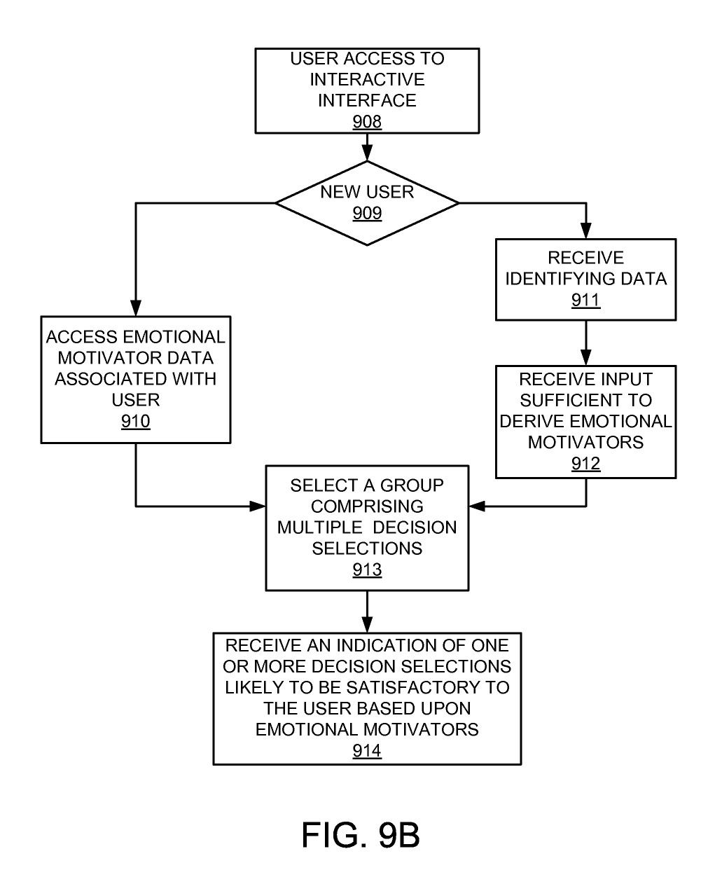

Referring now to FIG. 9A, a flow chart is illustrated with method steps that may be incorporated into some embodiments of the present invention. The method steps are presented as exemplary and are not required to be executed in a particular order.

At 901, a user, such as a Decision who is contemplating a Decision for either themselves or for a beneficiary, may access an interactive interface provided by automated apparatus, such as a controller included in a computer server, some preferred embodiments may include access via the Internet or via a mobile phone network, such as, for example, a 3G or 4G network or other cellular or WiFi network.

At 902, the user may provide user identification and at 903 the user may receive a unique identifier, such as, for example in some embodiments, a UUID (universally unique identifier).

At 904, the user may receive a set of multiple images, wherein each respective image is indicative of one or more emotional motivators. At 905, the user may provide input indicative of which image or images represent an answer to a question provided to the user related to the multiple images.

At 906, the user may also receive one or more questions relating to emotional motivators. Questions may be presented, for example via written text or via audio. At 907, the user may provide input indicative of an answer to the multiple respective questions. Answers to the multiple questions will be used to associate emotional motivators with the user.

At 907, in some embodiments, a server may receive an indication of a social media account and be granted access to the content of the social media account. At 908, the server may also relate Emotional Qualifiers to the content of the social media account.

Referring now to FIG. 9B, additional method steps are illustrated that may be used to implement some embodiments of the present invention. At 908, a user may access an interactive interface made available via an automated controller, such as one included in a computer server, some preferred embodiments may include access via the Internet or via a mobile phone network, such as, for example, a 3G or 4G network or other cellular or WiFi network.

At 909, the user may indicate whether the user is a new user or already has a profile including emotional motivator data associated with the user. If the user already provided data indicative of the user's emotional motivators, at 910 the system will access the emotional motivator data associated with the user.

If the user is a new user, or for some other reason the server does not have data associated with the user, at 911, the system may receive user identifying data and at 912 receive input sufficient to associate or otherwise derive emotional motivator motivators with the user.

At 913, the user may select a group including multiple products or services and the user may receive an indication of one or more Products or Services most likely to be satisfactory to the user based upon the emotional motivators associated with the user.

At 914, the user will receive a link to a point of Decision and indicate one or more Decision Selections which will be satisfactory to the user. In some embodiments, the point of Decision may be a virtual storefront, or other electronic marketplace or webpage, wherein the Decision Maker may complete a Decision of a Product via a linked Internet site. In other embodiments, the point of Decision may include a brick and mortar place of an event. A brick and mortar place of an event may include one or more venues for a social event determined to be geographically accessible to the user, such as a theater, a restaurant, or a university in close proximity to the user, such that the user may reasonably travel to the venue and make a Decision. A reasonable travel may be based upon a time and cost of travel in relation to a pecuniary value associated with a related Decision.

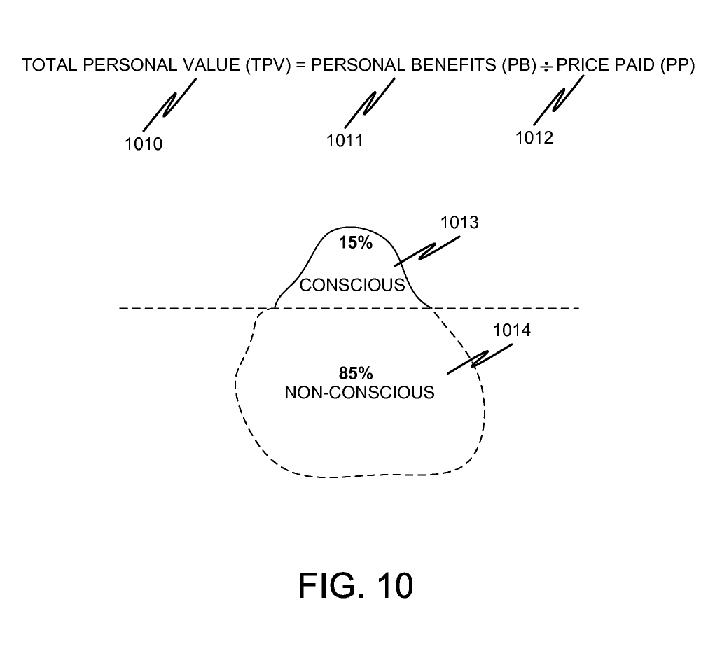

Referring now to FIG. 10, a block diagram illustrates a definition of Total Person Value 1010. According to the present invention, Total Personal Value 1010 may be defined as Personal Benefit 1011 divided by a price paid 1012 for the Personal Benefit 1011. A price paid 1012 may be based upon a pecuniary amount paid for the Personal Benefit 1011 or an emotional investment. Personal Benefit 1011 may include receipt of Emotional Motivators by the user. Personal Benefits 1011 may include conscious benefits 1013 and non-conscious benefits 1014.

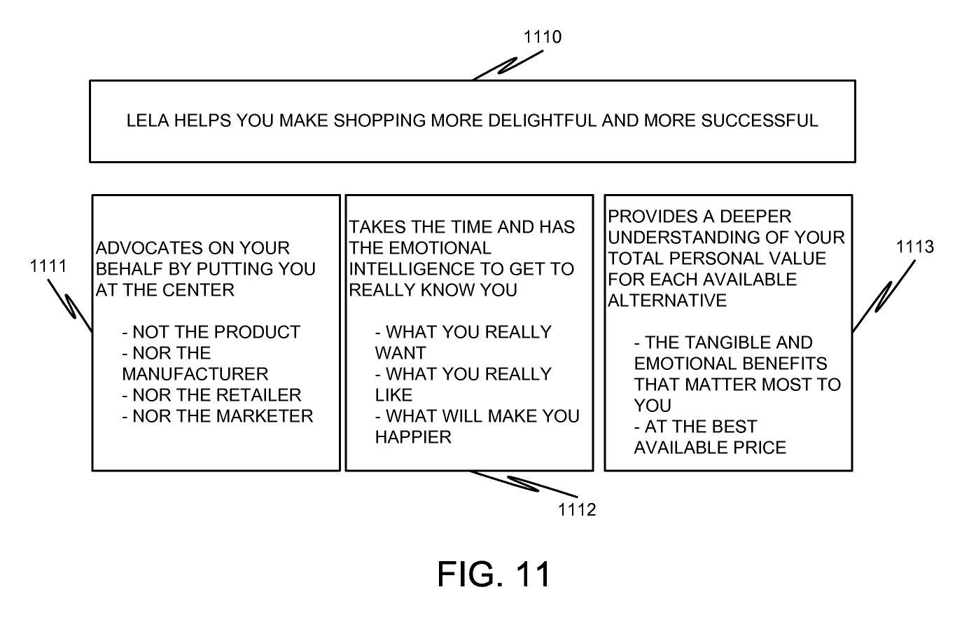

Referring now to FIG. 11, a block diagram illustrates some aspects of the present invention. At 1110, an implementation of the present invention includes a service, such as Lela that will help a Decision Maker make shopping more delightful and successful by being a virtual advocate for the user. Lela advocates according to emotional intelligence that Lela generates about the user.

At 1111, the present invention is capable of advocating for the user on the user's behalf by putting the user at the center of the advice provided, based upon Emotional Motivators associated with eh user. This differs from other methods in the user is who is advocated for, not a product, or a manufacturer, or a retailer or a marketer. It is all about the user.

At 1112, the present invention may take the time to get to really “know” the user, based upon Emotional Motivators. The present invention advocates and provides suggestions based upon what the user really wants, what the user really likes and ultimately what will make the user happy. At 1113, the present invention provides a deeper understanding of the user's Total Personal Value for available alternatives. The present invention provides knowledge as to the tangible benefits that matter most to the user, and in some embodiments, as a best available price.

### Conclusion

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware may be implemented. Accordingly, other embodiments are within the scope of the following claims.

What is claimed is:

1. Apparatus for making a recommendation of an answer selection based upon emotional motivators and emotional qualifiers, the apparatus comprising:
a computerized server comprising a processor and a digital storage in logical communication with a digital communications network; and
executable software stored on the digital storage and executable on demand, the software operative with the processor to cause the apparatus to:
transmit via the digital communications network a Decision Maker interface comprising answer selections;
receive a selection of one or more answer selection a Decision Maker has interest in;
receive a list of Emotional Qualifiers associated with the one or more answer selections the Decision Maker has interest in;
correlate Emotional Motivators associated with the Decision Maker with Emotional Qualifiers associated with one or more answer selections which the Decision Maker is interested in; and
transmit a suggested answer selection based upon the correlation of Emotional Motivators associated with the Decision Maker with Emotional Qualifiers associated with one or more answer selections.

2. The apparatus of claim 1 wherein the software is additionally operative to transmit a list comprising multiple answer selections, wherein the answer selections are ranked according to correlation of Emotional Motivators associated with the Decision Maker with Emotional Qualifiers associated with one or more answer selections.

3. The apparatus of claim 2 wherein the decision to be made by the Decision Maker comprises a pet to acquire.

4. The apparatus of claim 2 wherein the decision to be made by the Decision Maker comprises a person to spend time with.

5. The apparatus of claim 2 wherein the decision to be made by the Decision Maker comprises a university to attend.

6. The apparatus of claim 2 wherein the software is additionally operative to transmit a link associated with a venue for one or more of: Products, Services and Events, determined to be satisfactory to the Decision Maker based upon Emotional Motivators associated with the Decision Maker and Emotional Qualifiers associated with the respective one or more of: Products, Services and Events, determined to be satisfactory to the Decision Maker, wherein the venue is additionally based upon geographical location of the Products, Services and Events and the location of the Decision Maker.

7. The apparatus of claim 1 wherein the software is additionally operative to transmit data comprising an illustration of a Product or Service associated with the Emotional Qualifiers.

8. The apparatus of claim 1 wherein the software is additionally operative to transmit data comprising a history of Decision transactions completed by the Decision Maker.

9. The apparatus of claim 1 wherein the software is additionally operative to transmit data descriptive of social media content associated with the Decision Maker.

10. The apparatus of claim 1 wherein the software is additionally operative to transmit an indication of a user satisfaction level with a software engine which quantifies Emotional Motivators and makes Product recommendations based upon the Emotional Motivators.

11. The apparatus of claim 1 wherein the software is additionally operative to transmit data descriptive of Emotional Motivators associated with the Decision Maker.

12. The apparatus of claim 1 wherein the software is additionally operative to transmit Emotional Qualifiers associated with a Product, Service or Event chosen by the Decision Maker.

13. A method for making a recommendation of an answer selection based upon emotional motivators and emotional qualifiers, the method comprising:
transmitting from a controller and via a digital communications network, a Decision Maker interface comprising answer selections;
receiving a selection of one or more answer selection a Decision Maker has interest in;
receiving a list of Emotional Qualifiers associated with the one or more answer selections the Decision Maker has interest in;
correlating Emotional Motivators associated with the Decision Maker with Emotional Qualifiers associated with one or more answer selections which the Decision Maker is interested in; and
transmitting a suggested answer selection based upon the correlation of Emotional Motivators associated with the Decision Maker with Emotional Qualifiers associated with one or more answer selections.

14. The method of claim 13 additionally comprising the step of transmitting a list comprising multiple answer selections, wherein the answer selections are ranked according to correlation of Emotional Motivators associated with the Decision Maker with Emotional Qualifiers associated with one or more answer selections.

15. The method of claim 14 wherein the decision to be made by the Decision Maker comprises one or more of: a pet to acquire, a person to date, and a university to attend.

16. The method of claim 14 wherein method additionally comprises the step of transmitting a link associated with a venue for one or more of the Products, Services and Events determined to be satisfactory to the Decision Maker based upon emotional motivators associated with the Decision Maker and Emotional Qualifiers associated with the respective Products, Services and Events determined to be satisfactory to the Decision Maker, wherein the venue is additionally based upon geographical location of the Products, Services and Events and the location of the Decision Maker.

17. The method of claim 13 wherein the method additionally comprises the step of transmitting data comprising an illustration of a Product or Service associated with the Emotional Qualifiers.

18. The method of claim 13 wherein the method additionally comprises the step of transmitting data comprising a history of Decision transactions completed by the Decision Maker.

19. The method of claim 13 wherein the method additionally comprises the step of transmitting data descriptive of social media content associated with the Decision Maker.

20. The method of claim 13 wherein the method additionally comprises the step of transmitting an indication of a user satisfaction level with a software engine which quantifies Emotional Motivators and makes Product recommendations based upon the Emotional Motivators.
